(19) United States
(12) Patent Application Publication
(10) Pub. No.: US 2015/0372926 A1
(43) Pub. Date: Dec. 24, 2015

(54) LEAKY BUCKET MODEL TO MIMIC BEHAVIOR OF A MAC AND A METHOD THEREOF

(71) Applicant: XPLIANT, Inc, San Jose, CA (US)

(72) Inventors: Chirinjeev Singh, San Jose, CA (US); Vandana Desai, San Jose, CA (US)

(21) Appl. No.: 14/309,700

(22) Filed: Jun. 19, 2014

(51) Int. Cl. H04L 12/819

(52) U.S. Cl. CPC H04L 47/21; H04W 28/0278

(57) ABSTRACT

Embodiments of a leaky bucket model relate to simulation of a MAC (media access control) to enable verification of a core logic and the MAC without the MAC being physically available. The simulated MAC is typically implemented on a computing device that is in communication with the core logic and a SerDes (serializer/deserializer). The simulated MAC uses a leaky bucket model to determine behavior of the core logic and the MAC.

### FIELD OF INVENTION

The present invention relates to data transmission. More particularly, the present invention relates to a leaky bucket model to mimic behavior of a MAC and a method thereof.

### BACKGROUND OF THE INVENTION

In a design cycle, off-the-shelf components can be used to test a networking device that is under development. However, unavailability of one or more of these commercially available components can significantly delay testing of the networking device. Such a delay can, in turn, cause critical manufacturing and release dates of the networking device to be missed, resulting in a potentially large revenue loss.

### BRIEF SUMMARY OF THE INVENTION

Embodiments of a leaky bucket model relate to simulation of a MAC (media access control) to enable verification of a core logic and the MAC without the MAC being physically available. The simulated MAC is typically implemented on a computing device that is in communication with the core logic and a SerDes (serializer/deserializer). The simulated MAC uses a leaky bucket model to determine behavior of the core logic and the MAC.

In one aspect, a non-transitory computer-readable medium is provided. The non-transitory computer-readable medium stores instructions that, when executed by a computing device, cause the computing device to perform a method to simulate a MAC. The method includes maintaining a counter.

The method also includes adding bytes to the counter for each write by a core logic to the simulated MAC. In some embodiments, at a SOF, one SOF byte is compensated. In some embodiments, at an EOF, one EOF byte is compensated. In some embodiments, IPG and preamble are also compensated.

The method also includes subtracting from the counter based on a programmed rate. In some embodiments, the programmed rate is based on a rate of a SerDes.

The method also includes determining whether value of the counter is above a predetermined threshold. In some embodiments, the predetermined threshold is based on a size of a buffer that is located between the simulated MAC and the core logic on an egress of the core logic.

The method also includes, based on the determination that the value of the counter is above the predetermined threshold, asserting flow control of the core logic.

In one aspect, a non-transitory computer-readable medium is provided. The non-transitory computer-readable medium stores instructions that, when executed by a computing device, cause the computing device to perform a method to simulate a MAC. The method includes defining parameters of a bucket. Defining parameters of a bucket typically includes setting a threshold of the bucket is set to model flow control of the simulated MAC to a core logic. In some embodiments, the threshold is based on a size of a buffer that is located between the simulated MAC and the core logic on an egress of the core logic. Defining parameters of a bucket also typically includes setting a leak rate of the bucket. In some embodiments, the leak rate is based on a rate of a SerDes.

The method also includes determining whether a start of frame has occurred and determining whether the bucket is empty. Based on the determination that a start of frame has occurred and that the bucket is empty, the method also includes asserting an underrun condition of the core logic.

In some embodiments, the method also includes performing a bandwidth analysis of data through the simulated MAC to assess whether a line from the SerDes is fully utilized.

In one aspect, a non-transitory computer-readable medium is provided. The non-transitory computer-readable medium stores instructions that, when executed by a computing device, cause the computing device to perform a method to simulate a MAC. The method includes defining a threshold of a bucket based on a size of a buffer. The buffer is located between the simulated MAC and the core logic on an egress of the core logic.

The method also includes defining a leak rate of the bucket based on a rate of a SerDes.

The method also includes determining a current size of content in the bucket. The determination is typically based on writes by a core logic to the simulated MAC and based on the leak rate.

The method also includes asserting a flow control of the core logic when the current bucket size is greater than the threshold.

The method also includes detecting an underrun condition of the core logic when a start of frame has occurred and the bucket is empty.

In some embodiments, the method also includes determining whether bandwidth through the simulated MAC is less than the rate of the SerDes to assess whether a line from the SerDes is fully utilized.

In yet another aspect, a system is provided. The system includes a core logic, a SerDes and a computing device. The computing device is in communication with the core logic and the SerDes.

The computing device typically includes memory and an application stored in the memory. The application typically implements a leaky bucket model to simulate a MAC and uses a counter to keep track of an amount of data that needs to be forwarded by the simulated MAC.

In some embodiments, the counter adds bytes that the core logic writes to the simulated MAC, plus compensation for SOF byte, EOF byte, IPG and preamble. In some embodiments, the counter subtracts leak bytecount bytes based on a speed of SerDes.

In some embodiments, the leaky bucket model includes a threshold to model flow control of the simulated MAC to the core logic. The threshold is based on a size of a MAC-core logic FIFO.

In some embodiments, the application is configured to determine whether the core logic underruns. Based on the determination, the application is configured to assert an underrun condition.

In some embodiments, the application is configured to perform bandwidth analysis of data through the simulated MAC.

In some embodiments, the application is configured to determine behavior of the core logic and the simulated MAC.

In yet another aspect, a computing device is provided. The computing device includes a memory, a first interface to couple with a core logic, and an application stored in the memory. Typically, the application implements a leaky bucket model to mimic behavior a currently unavailable networking device. In some embodiments, the currently unavailable networking device is a MAC. Typically, the application allows parameters of a bucket to be programmably defined.

In some embodiments, the parameters includes a threshold of the bucket and a leak rate of the bucket.

In some embodiments, the application is able to determine current size of content in the bucket, assert flow control of the core logic when the current bucket size is greater than the threshold, and detect an underrun condition of the core logic when the bucket is empty and a start of frame has occurred.

In some embodiments, the computing device also includes a second interface to couple with a SerDes.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 illustrates a block diagram of an exemplary system in accordance with some embodiments of the present invention.

FIG. 2 illustrates a diagram of the leaky bucket model in accordance with some embodiments of the present invention.

FIG. 3 illustrates a method of a simulated MAC in accordance with some embodiments of the present invention.

FIG. 4 illustrates another method of the simulated MAC in accordance with some embodiments of the present invention.

FIG. 5 illustrates yet another method of the simulated MAC in accordance with some embodiments of the present invention.

FIG. 6 illustrates a block diagram of an exemplary computing device in accordance with some embodiments of the present invention.

### DETAILED DESCRIPTION OF THE INVENTION

In the following description, numerous details are set forth for purposes of explanation. However, one of ordinary skill in the art will realize that the invention can be practiced without the use of these specific details. Thus, the present invention is not intended to be limited to the embodiments shown but is to be accorded the widest scope consistent with the principles and features described herein.

Embodiments of a leaky bucket model relate to simulation of a MAC (media access control) to enable verification of a core logic and the MAC without the MAC being physically available. The simulated MAC is typically implemented on a computing device that is in communication with the core logic and a SerDes (serializer/deserializer). The simulated MAC uses a leaky bucket model to determine behavior of the core logic and the MAC.

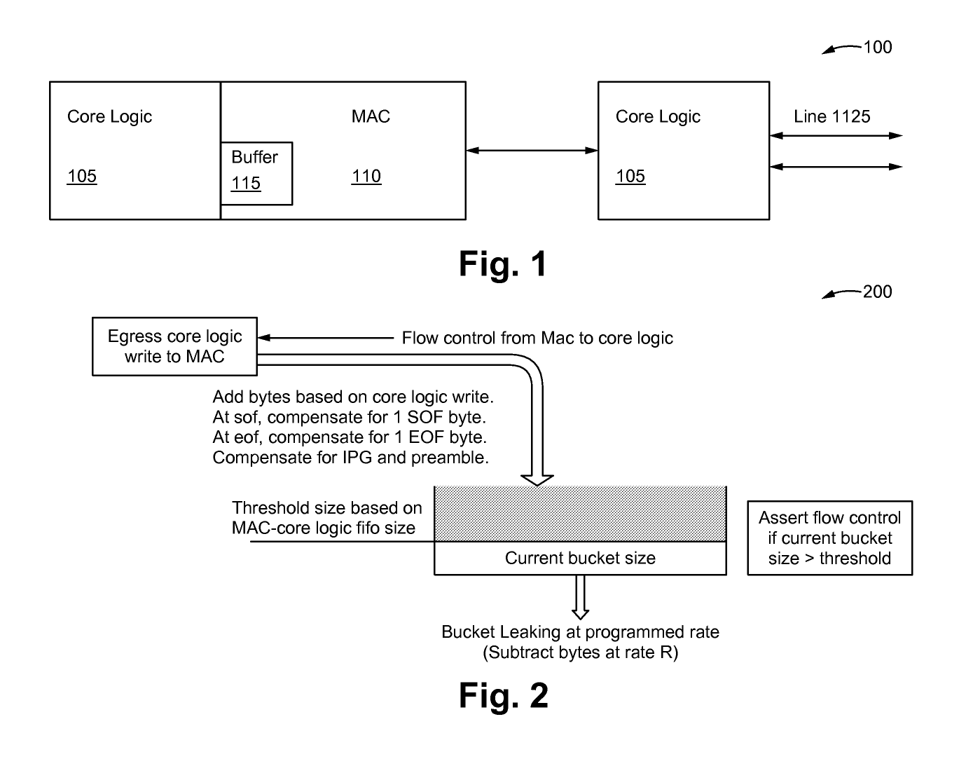

FIG. 1 illustrates a block diagram of an exemplary system 100 in accordance with some embodiments of the present invention. The system 100 includes block 105 that represents a core logic. The core logic 105 is in the form of a hardware device, such as a switch. Alternatively, the core logic 105 is in the form of software. The system 100 also includes block 110 that represents a MAC 110. The system 100 also includes a block 115 that represents a buffer 115, such as a FIFO queue. The buffer 115 is typically located between the MAC 110 and the core logic 105 on an egress of the core logic 105. The system 100 also includes block 120 that represents SerDes, which serializes data before sending the data out via a line 125 from the SerDes 120. Typically, the core logic 105 is in communication with the MAC 110 which, in turn, is communication with SerDes 120.

The core logic 105 is able to write data to the MAC 110 at a very high speed. However, since the data is limited by what the SerDes 120 can support, the buffer 115 is used to flow control the core logic 105 to make sure that the MAC 110 sends out data at the proper rate, that is, at a rate that is no more than the rate of the line 125. The speed of the MAC 110 is typically based on the speed of the SerDes 120.

Assume the line rate of the line 125 is 10 Gbps and the write rate of the core logic 105 to the MAC 110 is 100 Gbps. However, the MAC 110 cannot send more data than the SerDes 120 is capable of, which is 10 Gbps. A flow control is thus generated to make sure that the core logic 105 does not send more than what the MAC 110 can send to SerDes 120.

In some embodiments, a leaky bucket model is used to model the MAC 110 in an application environment when the MAC 110 is physically unavailable. FIG. 2 illustrates a diagram 200 of the leaky bucket model in accordance with some embodiments of the present invention. The core logic 105 writing to the simulated MAC, specifically into the buffer 115, is analogous to adding liquid to the bucket. The bucket runs a counter, which adds the bytes that the core logic 105 writes to the simulated MAC, plus compensation for SOF (start of frame) byte, EOF (end of frame) byte, IPG (interpacket gap) and preamble. For example, the bucket adds 30 bytes on every write. In some embodiments, the IPG is programmed in the simulated MAC.

Packets forwarded by the simulated MAC to SerDes 120, specifically removed from the buffer 115, is analogous to draining or leaking liquid from the bucket. The bucket typically leaks based on a fixed rate, which is a function of an egress port (i.e., SerDes speed). The counter subtracts leak bytecount bytes based on the rate of transmission. For example, the bucket leaks at 20 bytes per 5 blocks.

A threshold is added to the bucket to model flow control of the simulated MAC to the core logic 105. The threshold, which is based on the size of the buffer 115, makes sure that the core logic does not write more than what the simulated MAC can handle. Assume the size of the buffer 115 is 128 bytes. Then, whenever the bucket has more than 128 bytes, flow control of the core logic 105 is asserted.

Table 1 illustrates an exemplary pseudo-code of the leaky bucket model 200.

```
TABLE 1
underrun = packet_in_progress & current_bucket_empty & leak;
bucket_empty = (current_bucket_size == 0);
if (write && sof && !eof)
    packet_in_progress = 1;
else if (write && !sof && eof)
    packet_in_progress = 0;
//Assuming drain Clk to be 625Mhz
leaky_bucketbytecount = (rate * 1000)/(625*8); //rate is assumed to be in
Gbps
leak = 1; //Leak on every drainClock
if (write & sof)
    first_packet_received = 1; //This signal detect first packet received
Bandwidth_less_than_linerate = bucket_empty & first_pkt_received;
```

The leaky bucket model 200 ensures that the core logic 105 does not underrun. Underrun occurs when there is a start of packet (i.e., SOF) in the bucket but then the bucket runs dry (i.e., empty). If the bucket runs dry, then the simulated MAC typically will send random garbage data to the line 125, which should be avoided. The leaky bucket model 200 is able to detect whether the bucket is empty while a packet is being transmitted. Based on the detection, an underrun condition is asserted.

The leaky bucket model 200 performs bandwidth analysis of data through the simulated MAC. To meet the line rate, the bucket should never run out of data once the first packet SOF is put in the bucket. The leaky bucket model 200 is able to check whether the bandwidth through the simulated MAC is less than the line rate. If the bandwidth through the simulated MAC is less than the line rate, then the bandwidth is not sufficient to fully utilize the line 125. If the bandwidth through the simulated MAC is greater than the line rate, then the buffer flow controls the core logic 105.

The leaky bucket model used in the simulated MAC enables verification without the actual MAC being available, enabling faster debug times and faster simulation time. Basic design problems such as packet underrun and bandwidth analysis can easily be done using this model. The leaky bucket model is able to mimic the MAC's behavior to monitor bitrate, to detect packet underruns and to monitor bandwidth.

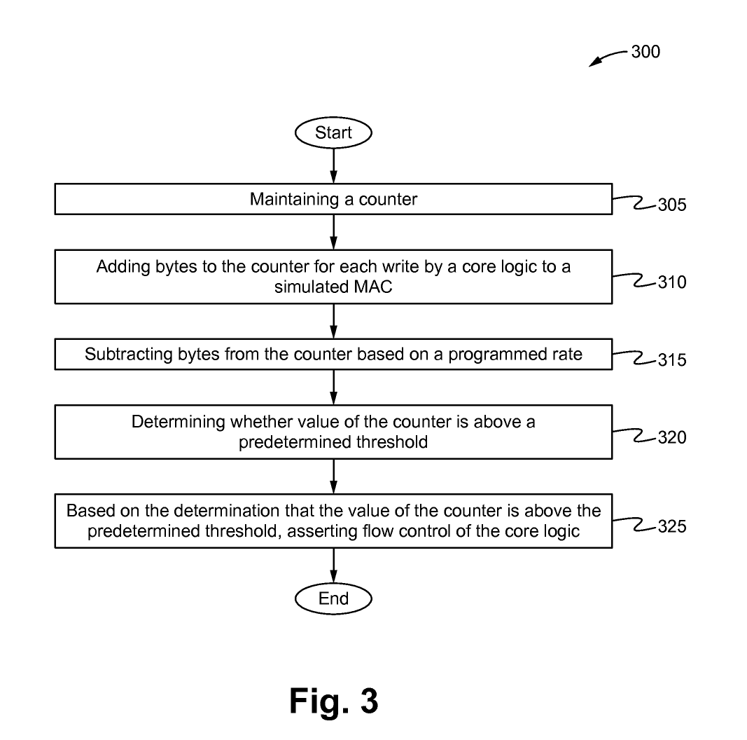

FIG. 3 illustrates a method 300 of the simulated MAC in accordance with some embodiments of the present invention. At a step 305, a counter is maintained.

At a step 310, bytes are added to the counter for each write by a core logic to the simulated MAC. At a SOF, one SOF byte is compensated. At an EOF, one EOF byte is compensated. IPG and preamble are also compensated. The step 310 is analogous to adding liquid to the bucket.

At a step 315, bytes are subtracted from the counter based on a programmed rate. The programmed rate is based on a rate of a SerDes. The step 315 is analogous to draining or leaking liquid from the bucket.

At a step 320, it is determined whether value of the counter is above a predetermined threshold. The predetermined threshold is based on a size of a buffer. The buffer is located between the simulated MAC and the core logic on an egress of the core logic. The step 320 is analogous to determining how much liquid is in the bucket.

At a step 325, based on the determination that the value of the counter is above the predetermined threshold, flow control of the core logic is asserted. The step 325 is analogous to controlling the flow of liquid into the bucket.

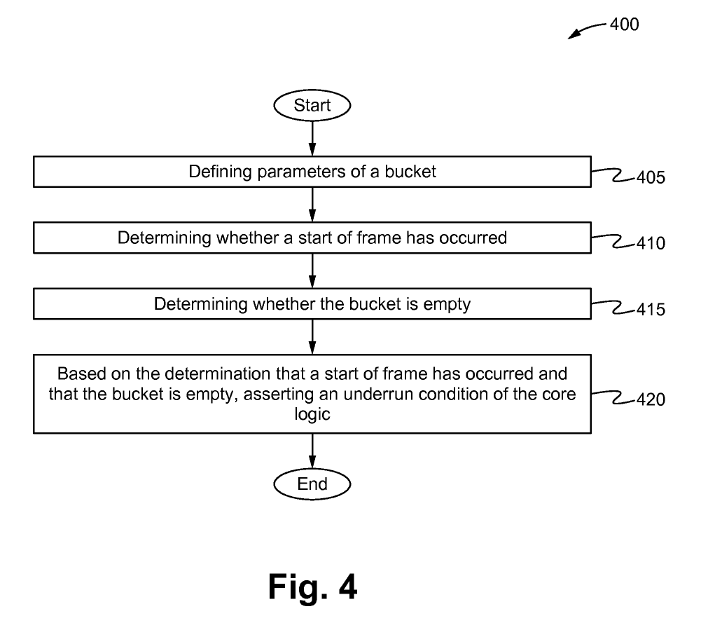

FIG. 4 illustrates yet another method 400 of the simulated MAC in accordance with some embodiments of the present invention. At a step 405, parameters of a bucket are defined. Typically, a threshold of the bucket is set to model flow control of the simulated MAC to a core logic. In some embodiments, the threshold is based on a size of a buffer that is located between the simulated MAC and the core logic on an egress of the core logic. In addition, a leak rate of the bucket is set. In some embodiments, the leak rate is based on a rate of a SerDes.

At a step 410, it is determined whether a start of frame has occurred.

At a step 415, it is determined whether the bucket is empty.

At a step 420, based on the determination that a start of frame has occurred and that the bucket is empty, an underrun condition of the core logic is asserted.

In some embodiments, bandwidth analysis of data through the simulated MAC can also be performed to assess whether a line from the SerDes is fully utilized.

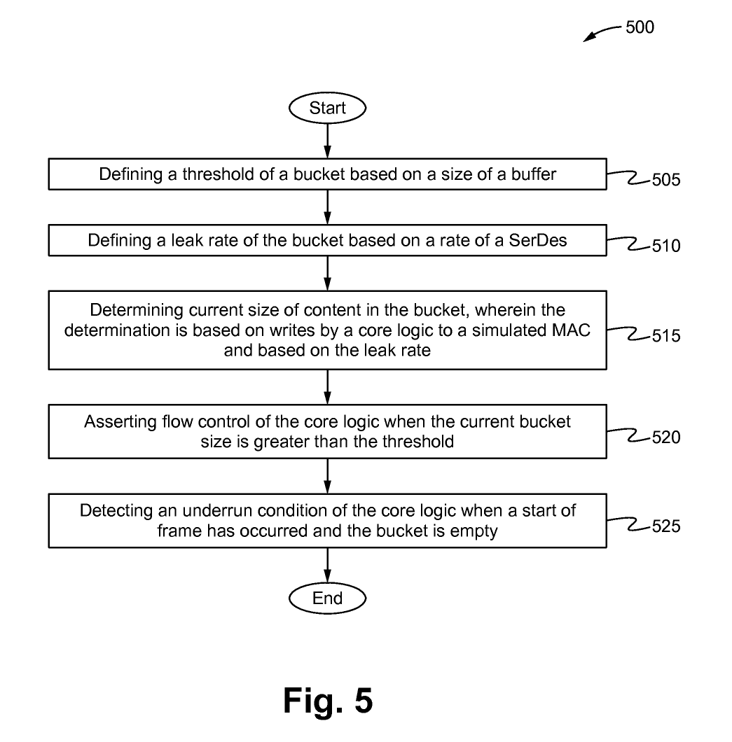

FIG. 5 illustrates yet another method 500 of the simulated MAC in accordance with some embodiments of the present invention. At a step 505, a threshold of a bucket is defined based on a size of a buffer. The buffer is located between the simulated MAC and the core logic on an egress of the core logic.

At a step 510, a leak rate of the bucket is defined based on a rate of a SerDes.

At a step 515, a current size of content in the bucket is determined. The determination is typically based on writes by a core logic to the simulated MAC and based on the leak rate.

At a step 520, flow control of the core logic is asserted when the current bucket size is greater than the threshold.

At a step 525, an underrun condition of the core logic is detected when a start of frame has occurred and the bucket is empty.

In some embodiments, it can also be determined whether bandwidth through the simulated MAC is less than the rate of the SerDes to assess whether a line from the SerDes is fully utilized.

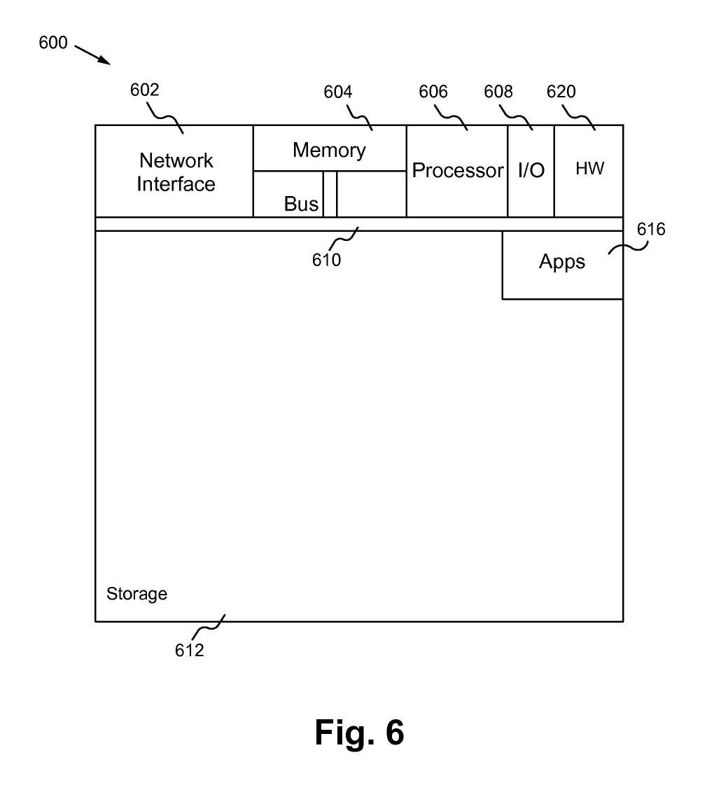

The simulated MAC is typically in an application environment running on a computing device. FIG. 6 illustrates a block diagram of an exemplary computing device 600 in accordance with some embodiments of the present invention. The computing device 600 is able to be used to acquire, cache, store, compute, search, transfer, communicate and/or display information.

In general, a hardware structure suitable for implementing the computing device 600 includes a network interface 602, a memory 604, processor(s) 606, I/O device(s) 608, a bus 610 and a storage device 612. The choice of processor 606 is not critical as long as a suitable processor with sufficient speed is chosen. In some embodiments, the computing device 600 includes a plurality of processors 606. The memory 604 is able to be any conventional computer memory known in the art. The storage device 612 is able to include a hard drive, CDROM, CDRW, DVD, DVDRW, flash memory card, RAM, ROM, EPROM, EEPROM or any other storage device. The computing device 600 is able to include one or more network interfaces 602. An example of a network interface includes a network card connected to an Ethernet or other type of LAN. The I/O device(s) 608 are able to include one or more of the following: keyboard, mouse, monitor, display, printer, modem, touchscreen, button interface and other devices. Application(s) 614, such as a program(s) implementing the simulated MAC, are likely to be stored in the storage device 612 and memory 604 and are processed by the processor 606. In some embodiments, the computing device 600 includes hardware modules 620 for coupling with other devices, such as the network switch. More or less components shown in FIG. 6 are able to be included in the computing device 600.

The computing device 600 can be a server, a desktop computer, a laptop computer, a netbook, or any suitable computing device such as special purpose devices.

When a MAC is unavailable, the leaky bucket model advantageously allows a networking device that is under development to be tested such that critical manufacturing and release dates of the networking device are not missed. The leaky bucket model simulates the MAC to enable verification and determine behavior of a core logic and the MAC.

One of ordinary skill in the art will realize other uses and advantages also exist. While the invention has been described with reference to numerous specific details, one of ordinary skill in the art will recognize that the invention can be embodied in other specific forms without departing from the spirit of the invention. Thus, one of ordinary skill in the art will understand that the invention is not to be limited by the foregoing illustrative details, but rather is to be defined by the appended claims.

We claim:

1. A non-transitory computer-readable medium storing instructions that, when executed by a computing device, cause the computing device to perform a method to simulate a MAC, the method comprising:
maintaining a counter;
adding bytes to the counter for each write by a core logic to the simulated MAC;
subtracting bytes from the counter based on a programmed rate;
determining whether value of the counter is above a predetermined threshold; and
based on the determination that the value of the counter is above the predetermined threshold, asserting flow control of the core logic.

2. The non-transitory computer-readable medium of claim 1, wherein the programmed rate is based on a rate of a SerDes.

3. The non-transitory computer-readable medium of claim 1, wherein the predetermined threshold is based on a size of a buffer, wherein the buffer is located between the simulated MAC and the core logic on an egress of the core logic.

4. The non-transitory computer-readable medium of claim 1, wherein adding bytes to the counter comprises:
at SOF (start of frame), compensating for one SOF byte;
at EOF (end of frame), compensating for one EOF byte;
compensating for IPG (interpacket gap); and
compensating for preamble.

5. A non-transitory computer-readable medium storing instructions that, when executed by a computing device, cause the computing device to perform a method to simulate a MAC, the method comprising:
defining parameters of a bucket, comprising:
setting a threshold of the bucket to model flow control of the simulated MAC to a core logic;
setting a leak rate of the bucket;
determining whether a start of frame has occurred;
determining whether the bucket is empty; and
based on the determination that a start of frame has occurred and that the bucket is empty, asserting an underrun condition of the core logic.

6. The non-transitory computer-readable medium of claim 5, wherein the threshold is based on a size of a buffer.

7. The non-transitory computer-readable medium of claim 5, wherein the leak rate is based on a rate of a SerDes.

8. The non-transitory computer-readable medium of claim 5, the method further comprising performing bandwidth analysis of data through the simulated MAC.

9. A non-transitory computer-readable medium storing instructions that, when executed by a computing device, cause the computing device to perform a method to simulate a MAC, the method comprising:
defining a threshold of a bucket based on a size of a buffer;
defining a leak rate of the bucket based on a rate of a SerDes;
determining current size of content in the bucket, wherein the determination is based on writes by a core logic to the simulated MAC and based on the leak rate;
asserting flow control of the core logic when the current bucket size is greater than the threshold; and
detecting an underrun condition of the core logic when a start of frame has occurred in the bucket and the bucket is empty.

10. The non-transitory computer-readable medium of claim 9, wherein the buffer is located between the simulated MAC and the core logic on an egress of the core logic.

11. The non-transitory computer-readable medium of claim 9, wherein the method further includes determining whether bandwidth through the simulated MAC is less than the rate of the SerDes.

12. A system comprising:
a core logic;
a SerDes; and
a computing device including memory and an application stored in the memory, wherein the application implements a leaky bucket model to simulate a MAC and uses a counter to keep track of an amount of data that needs to be forwarded by the simulated MAC.

13. The system of claim 12, wherein the computing device is in communication with the core logic and the SerDes.

14. The system of claim 12, wherein the counter adds bytes that the core logic writes to the simulated MAC, plus compensation for SOF byte, EOF byte, IPG and preamble.

15. The system of claim 12, wherein the counter subtracts leaky bucketbytecount bytes based on a speed of SerDes.

16. The system of claim 12, wherein the leaky bucket model includes a threshold to the bucket to model flow control of the simulated MAC to the core logic.

17. The system of claim 16, wherein the threshold is based on a size of a MAC-core logic FIFO.

18. The system of claim 12, wherein the application is configured to determine whether the core logic underruns.

19. The system of claim 18, wherein based on the determination, the application is configured to assert an underrun condition.

20. The system of claim 12, wherein the application is configured to perform bandwidth analysis of data through the simulated MAC.

21. The system of claim 12, wherein the application is configured to determine behavior of the core logic and the simulated MAC.

22. A computing device comprising:
a memory;
a first interface to couple with a core logic; and
an application stored in the memory, wherein the application implements a leaky bucket model to mimic behavior a currently unavailable networking device, wherein the application allows parameters of a bucket to be programmably defined.

23. The computing device of claim 22, wherein the currently unavailable networking device is a MAC.

24. The computing device of claim 22, wherein the parameters includes a threshold of the bucket and a leak rate of the bucket.

25. The computing device of claim 23, wherein the application is able to determine current size of content in the bucket, assert flow control of the core logic when the current bucket size is greater than the threshold, and detect an underrun condition of the core logic when the bucket is empty and a start of frame has occurred.

26. The computing device of claim 22, further comprising a second interface to couple with a SerDes.
